(19) United States
(12) Patent Application Publication
(10) Pub. No.: US 2017/0113620 A1
(43) Pub. Date: Apr. 27, 2017

(54) ELECTRONIC CIRCUIT FOR A BLIND-SPOT MONITORING DISPLAY

(71) Applicant: SMR Patents S.à.r.l., Luxembourg (LU)

(72) Inventor: Daniel Fritz, Stuttgart (DE)

(73) Assignee: SMR Patents S.à.r.l., Luxembourg (LU)

(21) Appl. No.: 15/310,620

(22) PCT Filed: May 5, 2015
(86) PCT No.: PCT/IB2015/053278

§ 371 Date: Nov. 11, 2016

(30) Foreign Application Priority Data
May 12, 2014 (EP) 14167967.0

(51) Int. Cl. B60R 1/12; B60R 1/06; H05B 33/08; B60Q 9/00

(52) U.S. Cl. CPC B60R 1/12; B60Q 9/008; B60R 1/06; H05B 33/089; H05B 33/0872; B60Q 2400/00; B60R 2001/1215

(57) ABSTRACT

The invention relates to an electronic circuit for a blind-spot monitoring display, having a circuit carrier; a first light source and a second light source mounted to the circuit carrier. A circuit connection is mounted to the circuit carrier, which circuit connection is coupled to the first light source and the second light source. The electronic circuit comprises circuit means which are designed, on the basis of a polarity of a voltage applied to the circuit connection to supply current either to the first light source or to the second light source.

### CROSS-REFERENCE TO RELATED APPLICATIONS

This application is the National Phase of International Application PCT/IB2015/053278 filed May 5, 2015 which designated the U.S. and that International Application was published on Nov. 19, 2015 as International Publication Number WO 2015/173692A1. PCT/IB2015/053278 claims priority to European Patent Application No. 14167967.0, filed May 12, 2014. Thus, the subject nonprovisional application claims priority to European Patent Application No. 14167967.0, filed May 12, 2014. The disclosures of both applications are incorporated herein by reference in their entirety.

### BACKGROUND OF THE INVENTION

The present invention relates to an electronic circuit for an illumination device in a review device for a motor vehicle, a driver-assistance system comprising such a circuit, a rear-view device having such an electronic circuit, a method for producing such a circuit and a motor vehicle having such a rear-view device and/or having such an electronic circuit.

Driver-assistance systems perceive, and interpret, the environment of the vehicle on the basis of environment sensors such as radar, video, infra-red and ultrasound. They support the driver in numerous driving situations and thereby increase driver comfort and driver safety. Driver-assistance systems contribute to increasing safety by supporting the driver in critical situations in which fast and safe action is necessary. In dangerous situations in which vehicles are located in the blind spot, i.e. in the area around the vehicle which a driver cannot see, a blind-spot monitoring supports the driver by displaying potential dangers caused by vehicles being located in the blind spot of the vehicle. The space available in the vehicle for accommodating an electronic circuit for the blind-spot monitoring display is limited, in particular in the exterior mirror of the vehicle, predetermined by the construction. The size of the available space in the area of the blind-spot display is limited. As a result, the module cannot be mounted to any extent at all or only at a single position. A multicoloured display that requires a three-pin connection is defined as requested by the customer. This limits the number of plugs available on the market and increases the required space available for the display. Additionally, three copper wires have to be laid to the display, which requires weight and space for laying cables in the base of the mirror and an additional plug-in space on the mirror-car connection.

An electronic circuit for a vehicle light not according to the preamble are known from US 2011/0291582 A1, US 2005/0254251 A1, EP 2 444 283 A2, DE 10 2004 042 107 A1 and EP 1 304 260 A1.

Electronic circuits for illumination devices not according to the preamble are known from EP 2 375 866 A1, US 2012/0153847 A1, an WO 2005/084080 A2.

The invention provides a circuit which is as compact as possible for an illumination device.

### SUMMARY OF THE INVENTION

The invention is based on the recognition that, due to a circuit design of the illumination device, it is possible to operate two circuits using only two connectors. This extends the current state of the art for monochromatic displays with all the advantages to a dichromatic display. This dichromatic display can be achieved by inverting the polarity of the two connectors. To do this, the inverse-polarity protection diodes and light-emitting diodes required per specification can be connected such that the first chromatic circle can be connected having the first connector as positive terminal (+) and the second connector as ground (−) and the second chromatic circle having the first connector as ground (−) and the second connector as positive terminal (+). It is therefore possible using the current implementation of a BSM (Blind Spot Monitoring) module having a colour without changing the outer dimensions with two colours. This means that two, instead of three, pins can be used for controlling dichromatic BSM modules having same size of required space and the same pin as controlling monochromatic BSM modules.

Hereinafter, an electronic circuit for an illumination device and a driver-assistance system comprising such a circuit and a production method for such a circuit is described.

The object is achieved by an electronic circuit for a blind-spot monitoring display having a circuit carrier, having at least one first light source mounted to the circuit carrier, having at least one second light source mounted to the circuit carrier and having at least one circuit connection mounted to the circuit carrier which circuit connection is coupled to at least one of the at least one first light source and to at least one of the at least one second light source, wherein the electronic circuit comprises at least one first circuit means functionally assigned to at least one first light source and at least one second circuit means functionally assigned to at least one second light source, through which, corresponding to a voltage applied to the circuit connection, the first light source and/or the second light source can be supplied with current. The voltage applied to said circuit connection comprises an on-board voltage of a vehicle. The advantage of this is that said circuit can be used in a motor vehicle in order to serve as a blind-spot monitoring display, for example.

Furthermore, during operation, the first light source and the second light source emit light having different wavelengths. The advantage of this is that, using the electronic circuit, two independent light sources, for example of different colours, can be controlled independently of one another.

The light sources, connectors and circuit means to the circuit carrier can be mounted on the circuit carrier, beneath the mounted or also both on and beneath the circuit carrier. The circuit carrier can be a PCB (printed circuit board), for example of a pancake design or a sandwich design. The electronic components mounted to the circuit carrier can be mounted in SMD (surface-mounted devices) design, with the result that a very compact circuit is produced.

According to an embodiment of the electronic circuit, the circuit connection comprises two separate connectors.

The advantage of this is that the circuit connection can be designed in a particularly space-saving manner, if only two connectors are necessary for controlling two different light sources instead of the three connectors conventional thus far. Because the circuit connection can be connected to a remote control device via a cable, every connector for connecting the cable takes up a certain amount of installation space. In the event of only two connectors instead of three connectors, approximately 33 per cent of the installation space for the circuit connection can be saved.

According to an embodiment of the electronic circuit, the first light source and the second light source comprise light-emitting diodes (LEDs). The circuit is thus economical in production and compact in design because LEDs do not occupy much space. Moreover, LEDs have very strong luminance and can be produced in different colours.

According to an embodiment of the electronic circuit, the circuit means comprise two diodes inversely switched to one another. The advantage of this is that based on a polarity of voltage applied to the diodes inversely switched to one another, the diodes inversely switched to one another can activate or block a current path. This means that the diodes are particularly suited to define two states of the electronic circuit, based on a sign of the voltage attached to the diodes.

According to an embodiment of the electronic circuit, the two diodes switched inversely to one another comprise a first inverse-polarity protection diode switched in series with the first light source and a second inverse-polarity protection diode switched in series with the second light source. The advantage of this is that the first inverse-polarity protection diode can effectively protect the first light source from voltage of an incorrect polarity being applied to the first light source, which can lead to a disruption or at least an impairment of the first light source. The same applies to the second inverse-polarity protection diode in respect of the second light source.

According to an embodiment of the electronic circuit, the two serial connections of first light source and first inverse-polarity protection diode and second light source and second inverse-polarity protection diode are switched parallel to one another. The advantage of the parallel connection is that the circuit can be divided into two parallel paths, wherein either the first path or the second path conducts current. This means that either the first light source or the second light source is activated.

According to an embodiment, the electronic circuit has a capacitance which is switched parallel to the two serial connections of first light source and first inverse-polarity protection diode and second light source and second inverse-polarity protection diode. The advantage of this is that the capacitance can store the charge state of the circuit, with the result that the circuit can also continue to be operated if voltage is no longer applied to the circuit connection, with the result that energy can be saved. The voltage thus needs to be applied to the circuit connection only briefly for example, the state of the circuit is preserved because of the capacitance. A capacitor can be used as capacitance or/and the capacitance of the line between circuit connection and electronic components of the circuit can be used as capacitance.

According to an embodiment, the electronic circuit has a connection cable which connects the two serial connections of first light source and first inverse-polarity protection diode and second light source and second inverse-polarity protection diode to the circuit connection. The advantage of such a connection cable is that it can be designed to be very compact and simultaneously can serve as capacitance.

According to an embodiment of the electronic circuit, the capacitance is formed from the connection cable. The advantage of this is that components can be saved, and the spatial requirement for the circuit is even less.

According to an embodiment of the electronic circuit, said electronic circuit comprises an electronic circuit of a blind-spot monitoring display, and/or of a route indicator, in particular of an indicator. For example, in a blind-spot monitoring display, a green light can be signalled to the driver indicating that there is no danger, while a red light can signal that there is a vehicle located in the blind spot. At the same time, the installation size required for said blind-spot monitoring display is reduced if, instead of the previously customary three connections, only two connections are necessary without impacting on the comfort of said driver. Alternatively, a previously monochromatic blind-spot display can be operated as a dichromatic blind-spot display means having the same installation size.

The object is furthermore achieved by a driver-assistance system, comprising: a control device; an electronic circuit according to the above-described aspect of the invention or an embodiment thereof; and connection means, which are designed to connect the electronic circuit to the control device, wherein the control device comprises control means which are designed, on the basis of a state of the control device, to supply to the circuit connection of the electronic circuit a voltage of a first polarity or a voltage of a second polarity.

The above-described electronic circuit can be used for the most varied applications in a driver-assistance system, for example for the blind-spot monitoring display as described above, but also for other applications. For example, the circuit can be used for an indicator in order to thus signal the intention of the driver soon he wanting to charge the lane to vehicles driving alongside or behind the driver who are located outside of the radiation angle of the front or rear indicator. The advantage of such a system is also that the control unit need not be installed together with the electronic circuit in the vehicle, but can be located at other positions, say, at any position in the vehicle where there is sufficient space. The electronic circuit can be mounted at positions suitable for the driver, such as in the exterior mirror, for example. Thus not the entire control apparatus need to be designed compact, but it is sufficient if merely the electronic circuit is designed compact.

According to an embodiment of the driver-assistance system, the state of the control device is based on a blind-spot monitoring. The advantage of this is that the control device can be used to control the electronic circuit, in order to thus realize a blind-spot monitoring system. The control device can also be reprogrammed or can be set into another state in which the electronic circuit can be used for another application. The advantage of this is that the driver-assistance system can be used flexibly for the most different applications, indeed those which are not foreseeable in the moment of integrating the driver-assistance system.

According to an embodiment of the driver-assistance system, the control device adopts a first state, when actuating an indicator, which state indicates an indicator situation and, when the indicator is switched off, adopts a second state which indicates a daytime running light situation. The advantage of this is that the driver-assistance system can carry out not only blind-spot monitoring but can also handle other situations flexibly, such as the distinction between indicating state and daytime running light state described here. The indicator can automatically switch off the daytime running light in the optical guide, and switch daytime running light back on again after indicating.

Additionally, the object is achieved by a rear-view device for a motor vehicle having at least one electronic circuit, in particular having at least one of the aforementioned features. The rear-view device can for example comprise an internal mirror or exterior mirror.

Furthermore, the object is achieved by a method for producing an electronic circuit for an illumination device, having the steps: providing a circuit carrier; mounting a first light source and a second light source to the circuit carrier; mounting a circuit connection to the circuit carrier; and mounting circuit means to the circuit carrier, in order to interconnect the first light source and the second light source and connect same to the circuit connection, wherein the circuit means switch the first light source and the second light source inversely to one another and in each case secure the same using an inverse-polarity protection diode.

A circuit for a blind-spot monitoring display can be produced particularly simply using such a method. The electronic circuit produced using this method is particularly compact and needs little installation space.

According to a further embodiment of the electronic circuit, the circuit carrier can be designed as a lead frame, i.e. as a metallic or non-metallic conduction carrier which is used for producing semiconductor chips. The leads guided out, i.e. connections of the lead frame, can form the circuit connection. The lead frame can be placed in a chip package, together with the mounted electronic components. The electronic circuit can thus be realized as a chip. With such a realization, in addition to the circuit for blind-spot monitoring, the chip can also have other functionalities or/and can control further light sources with only two connectors. For example, a chip can recognize a state not only using a polarity of the voltage at the circuit connection, but also for example recognize a phase and/or amplitude of the voltage at the circuit connection, in order thus to provide a compact monitoring unit which has a plurality of states for controlling diverse traffic situations.

In a further embodiment, first light source or first light-emitting diode and first inverse-polarity protection diode can be designed as an integrated component, for example as a light-emitting diode with integrated inverse-polarity protection. Similarly, second light source or second light-emitting diode and second inverse-polarity protection diode can be designed as an integrated component, for example as a light-emitting diode with integrated inverse-polarity protection.

Finally, the object is achieved by a motor vehicle having a rear-view device, in particular having at least one of the aforementioned features, having a driver-assistance system, in particular having at least one of the aforementioned features, and/or having an electronic circuit, in particular having at least one of the aforementioned features.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic representation of a vehicle exterior mirror having integrated electronic circuit for a blind-spot monitoring display according to an embodiment;

FIG. 2a) is a schematic representation in top view on an electronic circuit for a blind-spot monitoring display according to an embodiment;

FIG. 2b) is a schematic representation of the electronic circuit from FIG. 2a) in a side view;

FIG. 3 is a circuit diagram of an electronic circuit for a blind-spot monitoring display according to an embodiment;

FIG. 4 is a schematic representation of a driver-assistance system according to an embodiment; and

FIGS. 5a) to 5d) are schematic representations of a method for producing an electronic circuit for a blind-spot monitoring display according to an embodiment.

### DETAILED DESCRIPTION OF THE PREFERRED EMBODIMENT

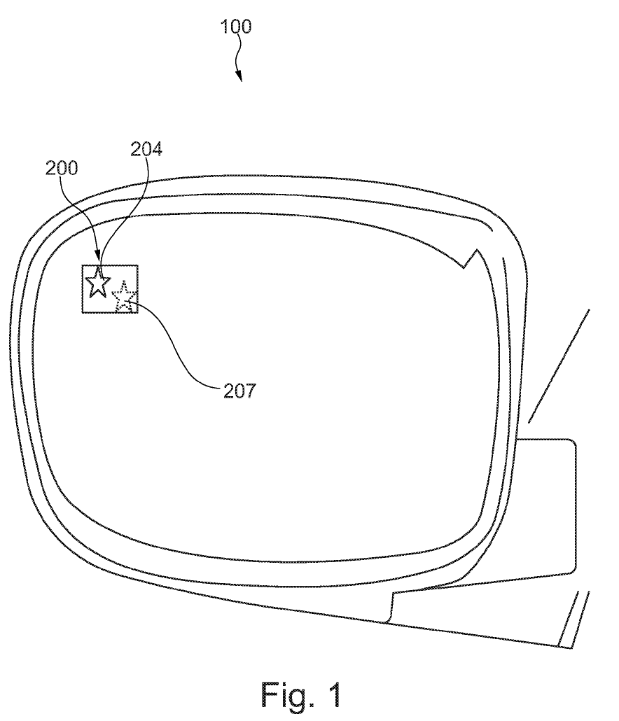

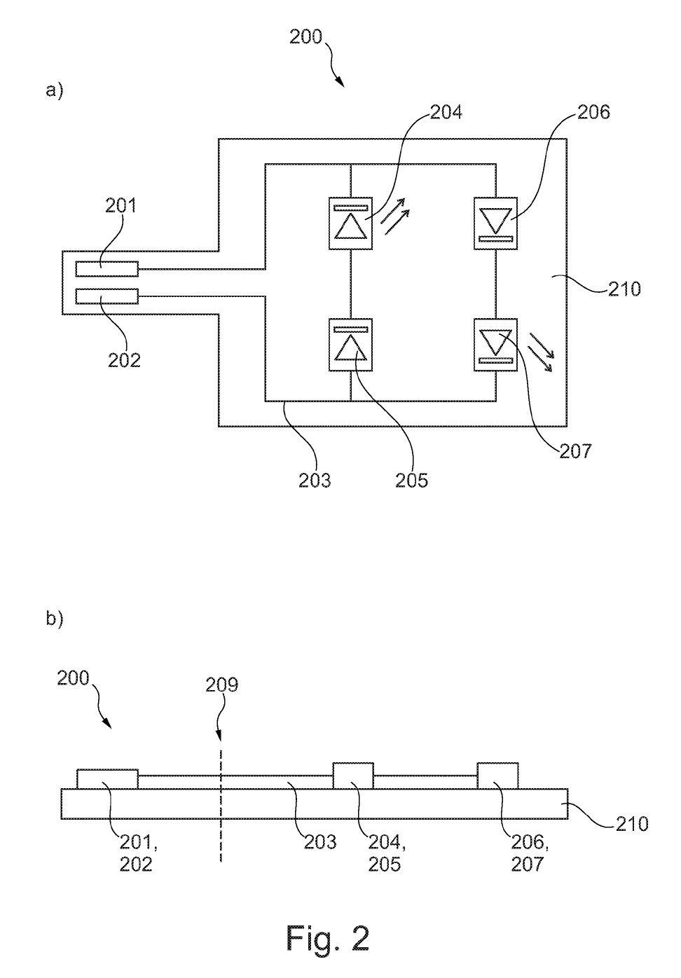

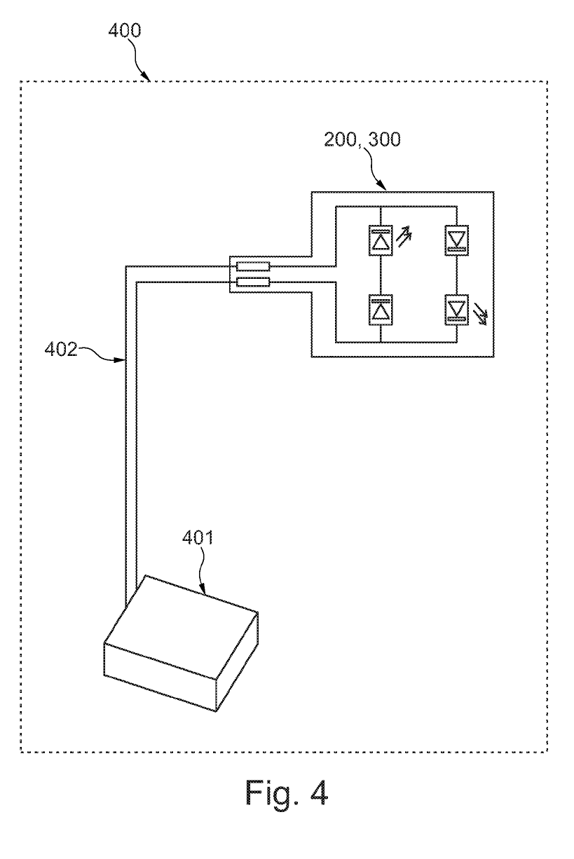

FIG. 1 shows a schematic representation of a vehicle exterior mirror 100 having an integrated electronic circuit 200 for a blind-spot monitoring display according to an embodiment. The electronic circuit 200 comprises two light sources 204, 207, represented by two stars which can be switched on or off alternately, for example by a control apparatus (not shown), which can be placed in the boot of the vehicle, as described in more detail in FIG. 4. The two light sources can be realized by light-emitting diodes (LEDs). The electronic circuit 200 is described in more detail below in respect of FIGS. 2a) and 2b). It comprises a circuit connection having two connectors, i.e. connectors to which a cable can be attached, as well as circuit means which make possible an alternate switching-on of the first light source 204 and the second light source 207. This means that either the first light source 204 lights up, for example in a first colour, e.g. green, or the second light source 207 lights up, for example in a second colour, e.g. red. The representation of FIG. 1 shows the circuit 200 in the state in which the first light source 204 is lighted up (e.g. in green) and the second light source 207 is switched off. This can display the “green” state, i.e. the blind-spot monitoring signals that no other vehicle is located in the blind spot of the actual vehicle. If the circuit 200 changes to “red” state, i.e. the blind-spot monitoring signals that another vehicle is located in the blind spot of the actual vehicle, the second light source 207 (e.g. in red) lights up and the first light source 204 is switched off. Because of the special circuit arrangement, as described in more detail in FIG. 2, this dichromatic monitoring with a circuit connection which requires only two connectors is possible.

FIG. 2a) shows a schematic representation in top view on an electronic circuit 200 for a blind-spot monitoring display according to an embodiment. The circuit 200 comprises an circuit carrier 210, a first light source 204 mounted to the circuit carrier 210, a second light source 207 mounted to the circuit carrier 210 as well as a circuit connection mounted to the circuit carrier 210 having two separate connectors 201, 202 coupled to the first 204 and second 207 light source via electronic interconnection.

The electronic circuit 200 furthermore comprises circuit means in the form of an electrical line or connection cable 203 as well as a first diode 205, for example an inverse-polarity protection diode, and a second diode 206, for example an inverse-polarity protection diode, which, on the basis of a polarity of a voltage applied to the circuit connection 201, 202, serve to supply either the first light source 204 or the second light source 207 with current. This can be guaranteed by means of the inverse interconnection of two diodes 205, 206. If, for example, there is a positive voltage between first connector 201 and second connector 202, then current flows through the second diode 206 and the second light source 207 while no current flows through the first diode 205 and the first light source 204. In the case of reversed polarity of the voltage applied, on the other hand, current flows through the first diode 205 and the first light source 204, while no current flows through the second diode 206 and the second light source 207; the circuit is in the state represented in FIG. 1.

The two light sources 204, 207 can be designed as diodes which have different colours.

The two diodes 205, 206 switched inversely to one another comprise a first inverse-polarity protection diode 205 switched in series with the first light source 204 and a second inverse-polarity protection diode 206 switched in series with the second light source 207, as can be seen from FIG. 2a. The two serial connections of first light source 204 and first inverse-polarity protection diode 205 and of second light source 207 and second inverse-polarity protection diode 206 are switched parallel to one another, as is apparent from FIG. 2a. The connection cable 203 serves to connect the two serial connections of first light source 204 and first inverse-polarity protection diode 205 and second light source 207 and second inverse-polarity protection diode 206 to the circuit connection 201, 202, i.e. to the two connectors 201, 202.

Furthermore, the electronic circuit 200 can have a capacitance which is switched parallel to the two serial connections of first light source 204 and first inverse-polarity protection diode 205 and second light source 207 and second inverse-polarity protection diode 206. A capacitance of a capacitor component is not represented in FIG. 2a. However, the capacitance can be formed from the capacitance of the connection cable 203.

The voltage applied to the two connectors 201, 202 can be an on-board voltage of a motor vehicle. The electronic circuit can thus be used in the automotive field.

FIG. 2b) shows a schematic representation of the electronic circuit 200 from FIG. 2a) in side view. The components, comprising a first 204 and a second 207 light source 204, a first 205 and a second 206 inverse-polarity protection diode as well as a connection cable 203, can for example be mounted on the circuit carrier 210 in a pancake design. The circuit carrier 210 can be a flexible circuit carrier, which is made in one piece. For example, the circuit carrier 210 and thus the circuit 200 can have a flexible or rigid bending edge 209, with the result that the part of the circuit 200 with the two connectors 201, 202 is arranged at an angle, e.g. approximately perpendicular, to the part of the circuit 200 with the two light sources 204, 207 and the two diodes 205, 206. This can be advantageous for being able to connect the circuit 200 more simply or even to arrange the connections of the circuit not in the visible range of the mirror 100 according to the representation of FIG. 1. The circuit 200 can, of course, also comprise further electronic components.

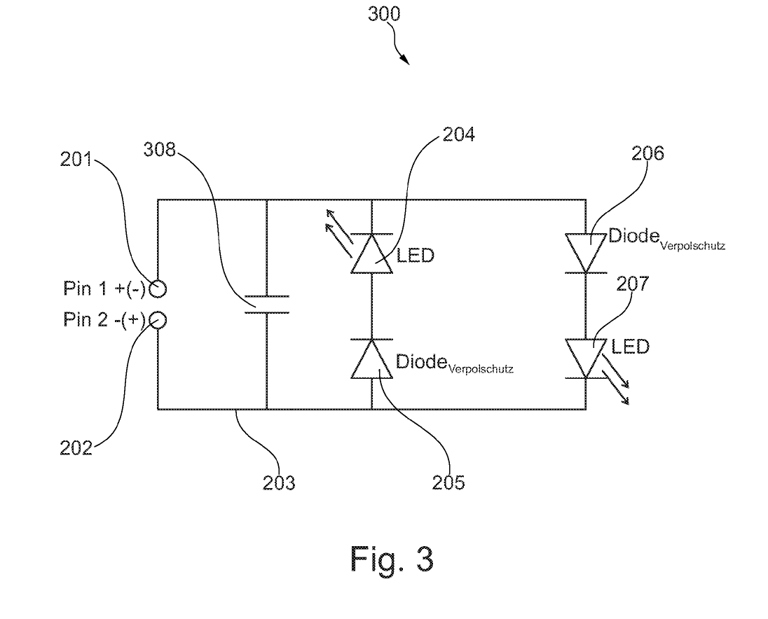

FIG. 3 shows a circuit diagram of an electronic circuit 300 for a blind-spot monitoring display according to an embodiment.

The circuit 300 comprises two circuit branches, each having a light-emitting diode (LED) 204, 207 and inverse-polarity protection diode 205, 206 arranged upstream. The inverse-polarity protection diode is intended to prevent voltage of reversed polarity from reaching respective LEDs 204, 207. Both circuit branches are switched parallel to one another at a circuit connection having a first connector 201 for connection to a voltage of a first polarity and a second connector 202 for connection to a voltage of a second polarity. Furthermore, the circuit 300 comprises a capacitor 308 which is switched parallel to both circuit branches likewise to the two connectors 201, 202.

In a first state of the circuit 300, the first polarity can be positive (+) and for example correspond to the positive terminal of a car battery and the second polarity can be negative (−) and for example correspond to the negative terminal or the ground of a car battery. In a second state of the circuit 300, the two terminals can be swapped, i.e. the first polarity can be negative (−) and for example correspond to the negative terminal or ground of a car battery and the second polarity can be positive (+) and for example correspond to the positive terminal of a car battery. The capacitor 308 can serve to store a charge state of the circuit 300. The circuit 300 can be produced on any circuit carrier, with the result that, for example, a circuit 200 can be produced as described in FIGS. 2a) and 2b). The capacitor 308 can be achieved by the line 203 or can be produced as an individual component. The circuit 300 can, of course, also comprise further electronic components.

FIG. 4 shows a schematic representation of a driver-assistance system 400 according to an embodiment. The driver-assistance system comprises a control device 401, a connection cable 402 and an electronic circuit 200, 300, for example in the form as described above with respect to FIGS. 2 and 3. The connection cable 402 serves as connection means in order to connect the electronic circuit 200, 300 to the control device 401. The control device 401 comprises control means by means of which a voltage of a first polarity or a voltage of a second polarity can be supplied to the circuit connection 201, 202 of the electronic circuit 200, 300 on the basis of a state of the control device 401. Therefore, it is possible to activate the first and second light source alternately, with the result that, depending on the state of the control device 401, the driver can be shown for example a green first LED indicating that no vehicle is located in the blind spot and a red second LED indicating that a vehicle is located in the blind spot. The control device 401 can be located at a suitable position in the vehicle where sufficient space is available and where the electronics can be shielded against disruptive influences. The electronic circuit 200, 300 can, on the other hand, be located directly in a position which is suitable and visible for the driver, for example in the exterior mirror 100, behind the surface of the mirror, as shown in FIG. 1. For the connection cable or the connection line 402, a two-wire cable, conventional in the automotive field, can be used, because the circuit 200, 300 can be controlled using only two connectors 201, 202.

The state of the control device 401 can be based not only on a blind-spot monitoring but can also comprise other driving situations. Thus the control device 401 can for example adopt a first state when actuating an indicator which indicates an indicator situation and when switching off the indicator adopts a second state which indicates a daylight driving situation.

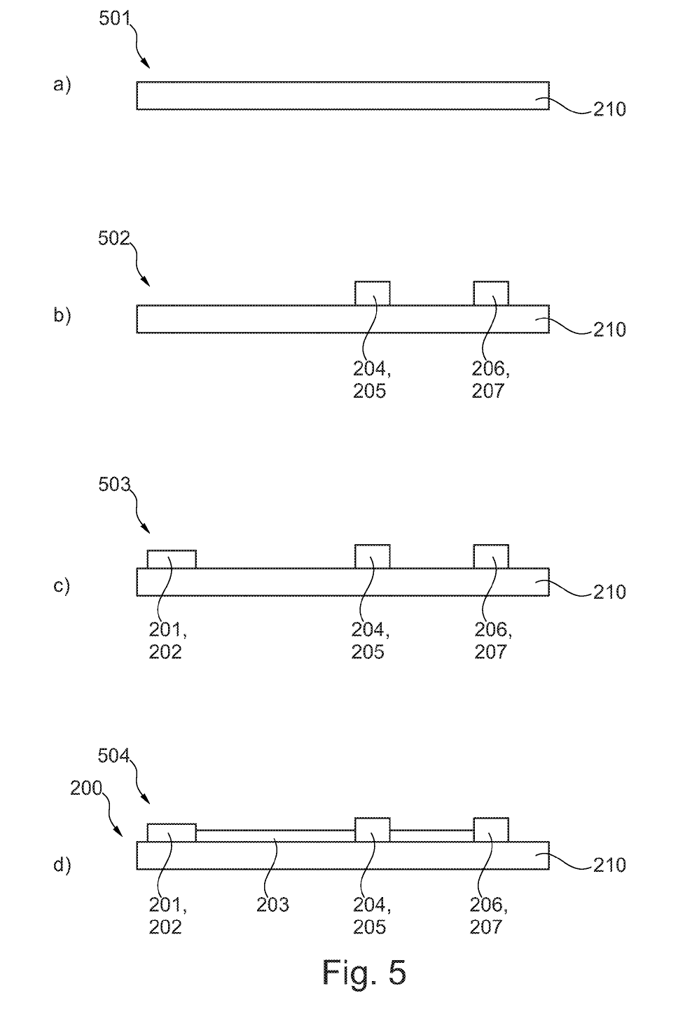

The FIGS. 5a) to 5d) show schematic representations of a method 501, 502, 503, 504 for producing an electronic circuit 200 for a blind-spot monitoring display according to an embodiment.

The method can comprise a first step 501 in which a circuit carrier 210 is provided, for example one such as described above in respect of FIG. 2. The method can comprise a second step 502 in which a first light source 204, e.g. an LED of a first colour, and a second light source 207, e.g. an LED of a second colour, can be mounted to the circuit carrier 210. The method can comprise a third step 503 in which a circuit connection having two connectors 201, 202 can be mounted to the circuit carrier 210. The method can comprise a fourth step 504 in which circuit means, for example a connection cable 203 and two diodes 205, 206, e.g. inverse-polarity protection diodes, can be mounted to the circuit carrier 210, in order to interconnect the first light source 204 and the second light source 207 and connect same to the circuit connection 201, 202. The circuit means 203, 205, 206 can be mounted to the circuit carrier 210, such that the first light source 204 and the second light source 207 are switched inversely to one another and are each secured using an inverse-polarity protection diode (205, 206). The production method can produce a circuit 200, as described above in respect of FIG. 2. The individual method steps can also be carried out in any other suitable order.

A further aspect of the invention comprises a computer program product which can be loaded directly into the internal memory of a digital computer and comprises software code segments, with which the method steps 501, 502, 503 and 504 of the method described in FIG. 5 can be executed if the product runs on a computer. The computer program product can be stored on a computer-suitable medium and can comprise the following: computer-readable programming means which prompt a computer to execute the method according to the description in respect of FIG. 5. The computer can be a part of a computer-controlled production machine with which a computer-controlled production can be realized.

A further aspect of the invention comprises a computer program product which can be loaded directly into the internal memory of a digital computer and comprises software code segments with which a control of the electronic circuit 200, 300 as described in FIGS. 2 and 3 can be executed if the product runs on a computer. The computer program product can be stored on a computer-suitable medium and can comprise the following: computer-readable program means which prompt a control device 401 as described above in respect of FIG. 4, on the basis of a state of the control device 401 to supply a voltage of a first polarity or a voltage of a second polarity to charge the circuit connection 201, 202 of the electronic circuit 200, 300. The computer can be part of the control device or the control device can represent the computer.

It is clear that the features of the different embodiments described herein by way of example can be combined with one another, unless specifically stated otherwise. As represented in the descriptions and the drawings, individual elements which have been represented as being in connection need not be connected to one another directly; intermediate elements can be provided between the connected elements. Furthermore, it is clear that embodiments of the invention can be implemented in individual circuits, partially integrated circuits or fully-integrated circuits or programming means. The term “for example” is meant merely as an example and not as the best or optimum. Specific embodiments have been illustrated and described herein, thus it is obvious to a person skilled in the art that a large number of alternative and/or uniform implementations can be realized instead of the shown and described embodiments, without deviating from the concept of the present invention.

The principle and mode of operation of this invention have been explained and illustrated in its preferred embodiment. However, it must be understood that this invention may be practiced otherwise than as specifically explained and illustrated without departing from its spirit or scope.

1. An electronic circuit an illumination device in a rear-view device for a motor vehicle, comprising:
a circuit carrier,
at least one first light source mounted to the circuit carrier,
at least one second light source mounted to the circuit carrier and
at least one circuit connection mounted to the circuit carrier which circuit connection is coupled to at least one of the at least one first light source and to at least one of the at least one second light source, wherein
the electronic circuit comprises at least one first circuit means functionally assigned to at least one first light source and at least one second circuit means functionally assigned to at least one second light source, through which, corresponding to a voltage applied to the circuit connection, the first light source and/or the second light source can be supplied with current, characterized in that, during operation, the first light source and the second light source emit light having different wavelengths, and wherein the voltage applied to the circuit connection comprises an on-board voltage of a motor vehicle.

2. The electronic circuit according to claim 1, wherein the circuit connection comprises two separate connectors.

3. (canceled)

4. The electronic circuit according to claim 1, wherein the first light source and the second light source comprise light-emitting diodes.

5. The electronic circuit according to claim 1, wherein the first circuit means and/or the second circuit means comprise two diodes switched inversely to one another.

6. The electronic circuit according to claim 5, wherein the two diodes switched inversely to one another comprise a first inverse-polarity protection diode switched in series with the first light source and a second inverse-polarity protection diode switched in series with the second light source.

7. The electronic circuit according to claim 6, wherein the two serial connections of first light source and first inverse-polarity protection diode and second light source and second inverse-polarity protection diode are switched parallel to one another.

8. The electronic circuit according to claim 7, wherein the electronic circuit has a capacitance which is switched parallel to the two serial connections of first light source and first inverse-polarity protection diode and second light source and second inverse-polarity protection diode.

9. The electronic circuit according to claim 8, wherein the electronic circuit has a connection cable which connects the two serial connections of first light source and first inverse-polarity protection diode and second light source and second inverse-polarity protection diode to the circuit connection.

10. The electronic circuit according to claim 9, wherein the capacitance comprises exclusively the connection cable.

11. The electronic circuit according to claim 1 wherein the electronic circuit comprises an electronic circuit of a blind-spot monitoring display and/or a route indicator.

12. A driver-assistance system, comprising:
a control device;
an electronic circuit according to claim 1, and
connection means which are designed to connect the electronic circuit to the control device,
characterized in that the control device comprises control means which are designed, on the basis of a state of the control device, to supply to the circuit connection of the electronic circuit a voltage of a first polarity or a voltage of a second polarity.

13. A rear-view device for a motor vehicle having at least one electronic circuit according to claim 1.

14. A method for producing an electronic circuit according to claim 1 for an illumination device, the method including the steps of:
providing a circuit carrier;
mounting a first light source and a second light source to the circuit carrier;
mounting a circuit connection to the circuit carrier; and
mounting circuit means to the circuit carrier, in order to interconnect the first light source and the second light source and connect same to the circuit connection,
wherein the circuit means switch the first light source and the second light source inversely to one another and in each case secure the same using an inverse-polarity protection diode.

15. A motor vehicle having at least one rear-view device according to claim 13, having at least one driver-assistance system according to claim 12, and/or having at least one electronic circuit according to claim 1.
